(19) United States
(12) Patent Application Publication
(10) Pub. No.: US 2003/0159319 A1
(43) Pub. Date: Aug. 28, 2003

(54) Display unit

(76) Inventors: Christopher Ransom, Hampshire (GB); John Ellis, Hants (GB)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/182,145

(22) PCT Filed: Jan. 26, 2001
(86) PCT No.: PCT/GB01/00312

(30) Foreign Application Priority Data
Jan. 27, 2000 (GB) 0001903.4

(51) Int. Cl. G09F 3/00; G09F 7/02

(52) U.S. Cl. 40/306; 40/312; 40/611.01

(57) ABSTRACT

A display unit (1) comprising two or more stackable containers (2), each of which has an opening (8) through which goods such as confectionery and snack foods being displayed can be removed, and in each of which can be inserted a removable sleeve (9) of material bearing advertising or other information.

This invention relates to a display unit, suitably for displaying goods such as confectionery and snack foods, in particular packets of crisps. The display unit of the invention will however have wider application for displaying consumer goods in general, for example fruits, batteries or computer games.

The present invention is concerned with an updateable floor standing display unit often referred to in trade terms as a dumpbin. Traditionally such displays are made out of cardboard and then replaced. They are by their nature semi permanent. In contrast, the display unit of the present invention is permanent and is updateable with slide-in graphics. Thus whenever a promotion changes, the unit is not replaced, but is simply updated with new graphics.

The invention provides a display unit comprising two or more stackable containers, each of which has an opening therein through which goods being displayed can be removed, and in each of which can be inserted a removable sleeve of material bearing advertising or other information.

The display unit of the invention suitably comprises a series of containers, which are preferably but not necessarily cylindrical in shape, and which are stacked one upon the other to form an upright cylindrical bin. The containers can be stacked one upon the other in a relatively simple manner, for example by the base of one container having a peripheral recess which rests on the peripheral lip of another container on which it is stacked. Alternatively, a structure could be employed in which the stacked containers are positively locked together.

The various containers, which may for example be two, tree, four or five in number, will suitably contain confectionery or snack foods such as packets of crisps. Each of the containers will have an opening therein through which the goods displayed can be removed, for example the opening can be simply an opening of appropriate shape through which the hand of the customer is inserted to remove the goods. Alternatively the opening in the container could be closable by a door.

A sleeve bearing advertising or other material is inserted into each container, for example by sliding the sleeve into the area immediately behind the outer skin of the container. Alternatively the containers could be double-walled, with the sleeve being fitted between the double walls. The sleeve comprising a slide-in graphic could be inserted from above, or simply unwrapped within the container and spread against the inner wall thereof. The sleeve itself is suitably of paper, cardboard or plastics material.

The sleeve will carry advertising or other material relating to the goods being displayed in the container (or optionally relating to different goods). It will be apparent that the sleeve of material can be readily removed from the container and replaced by another sleeve carrying different information, for example if the goods in the container are to be changed or if it desired to run an advertising or promotional campaign. Thus the cylindrical containers are graphically updateable using a slide-in graphic sleeve.

The uppermost container of the unit may be suitably of different form from the other containers, for example it may comprise an open container wherein a portion of the side wall thereof is omitted.

Alternatively the uppermost container of the unit may be provided with a lid which suitably snap-fits onto the container, so that the container and lid effectively become one piece. This helps to keep shipping costs to a minimum.

The display unit itself will be made of a highly durable material, and can be made in a range of different shapes and sizes, such as circular, semi-circular and triangular.

Although the display unit of the invention will comprise a number of stackable containers, for example a stack of four containers, a number of display units may be placed adjacent each other wherein the number of containers in one unit is different from the number of containers in another unit, to provide a desired overall visual effect.

The invention will be further described, by way of example only, with reference to the accompanying drawings, in which:

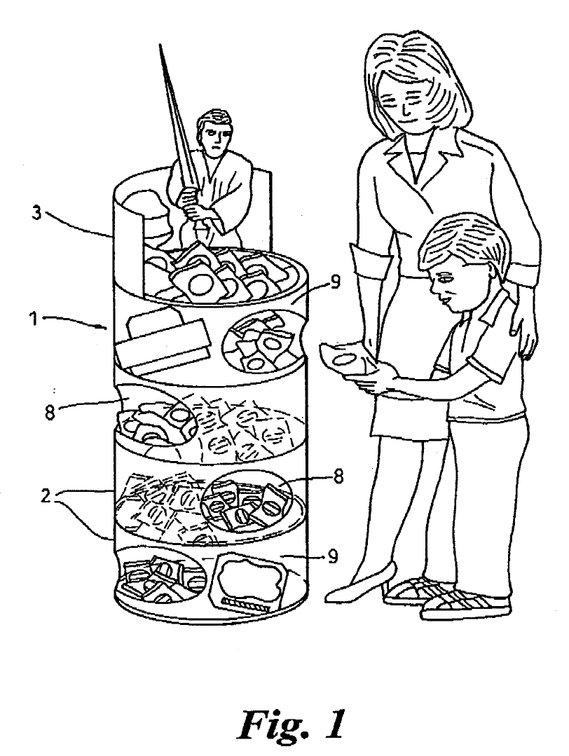

FIG. 1 shows one embodiment of a display unit of the invention, as it will appear to a customer;

FIG. 2 shows different types of the display unit, as a feature display;

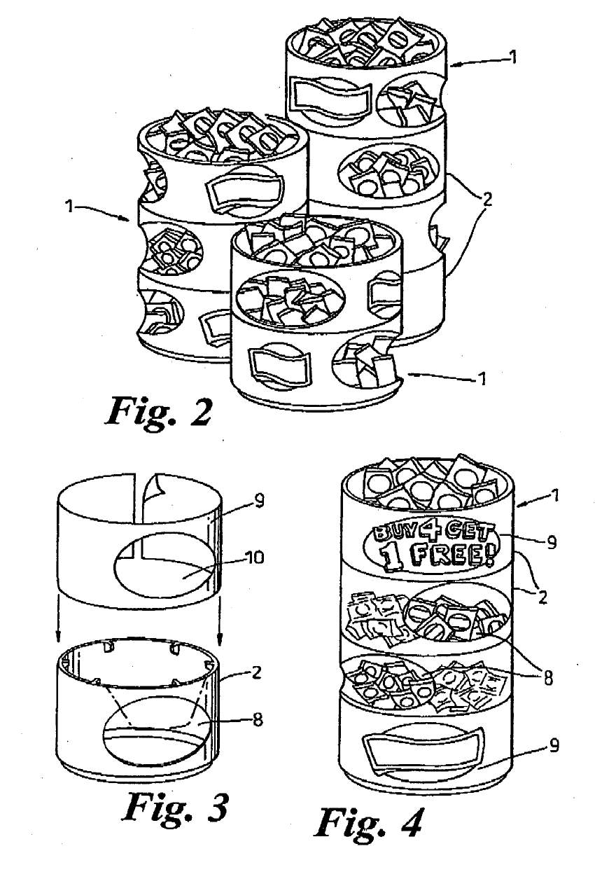

FIG. 3 shows how an updateable sliding graphic sleeve may be inserted in a container of the display unit;

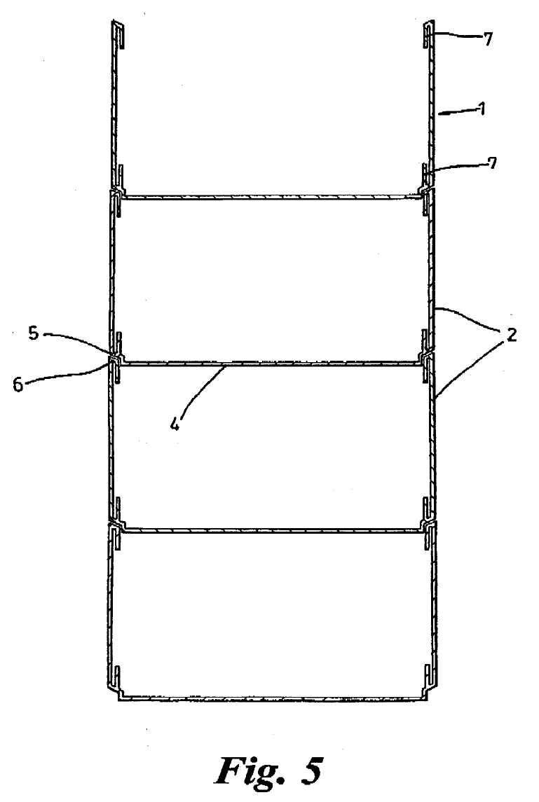

FIG. 4 shows a display unit wherein the sleeves of the various containers carry promotional and advertising material;

FIG. 5 is a cross-sectional view showing a display unit of the invention comprising four containers stacked one upon the other;

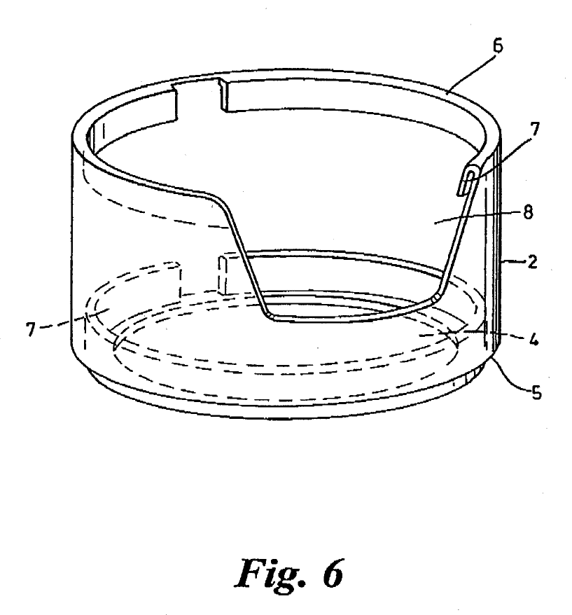

FIG. 6 is a perspective view of a single container of the display unit;

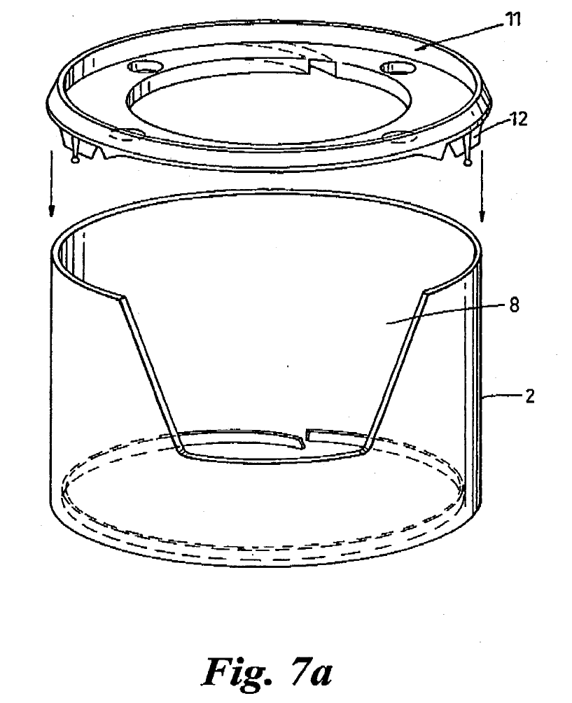

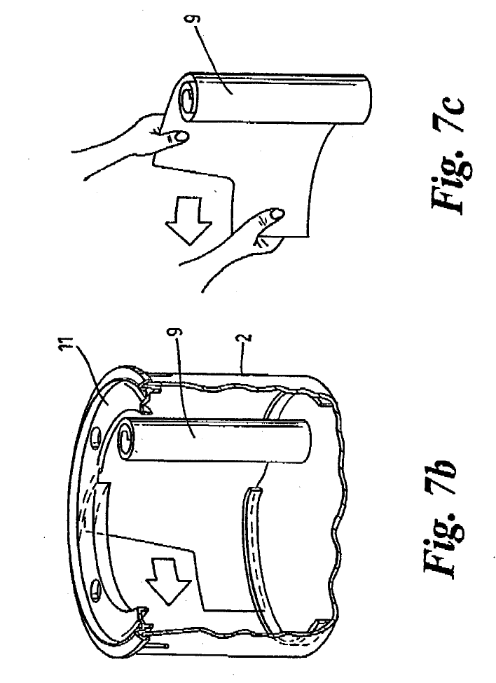

FIG. 7a is a perspective view of the upper container of a display unit of the invention, provided with a lid, of circular section:

FIG. 7b is a partially cut-away perspective view of the container of FIG. 7ashowing a graphic sleeve being unrolled within the container,

FIG. 7c shows the graphic sleeve itself which is inserted within the container;

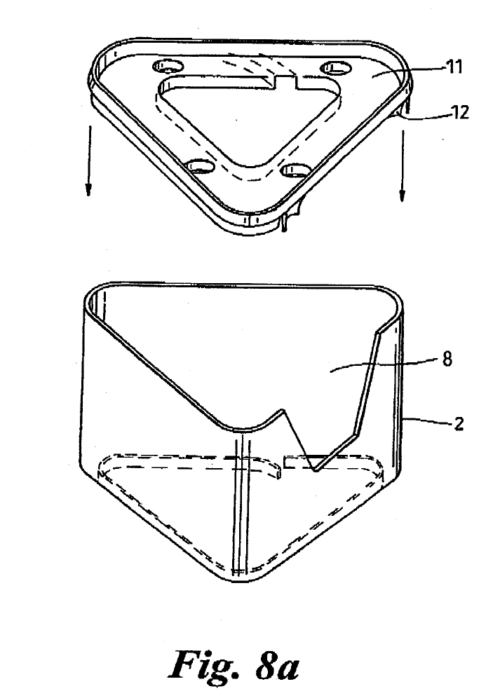

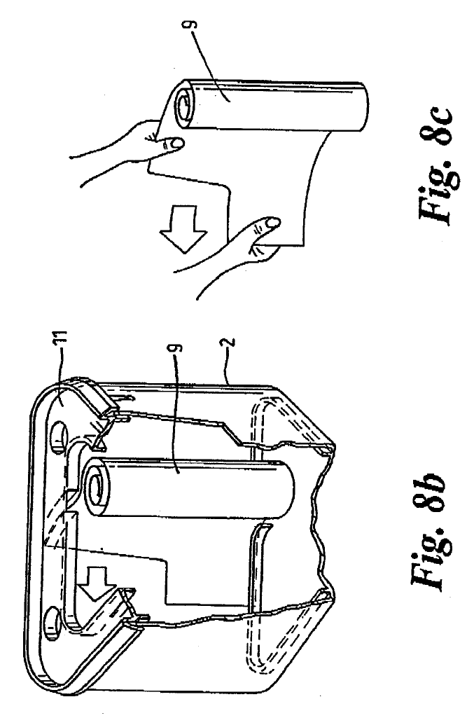

FIGS. 8a, 8b and 8c are views similar to FIGS. 7a, 7b and 7c, but illustrate a container of triangular section; and

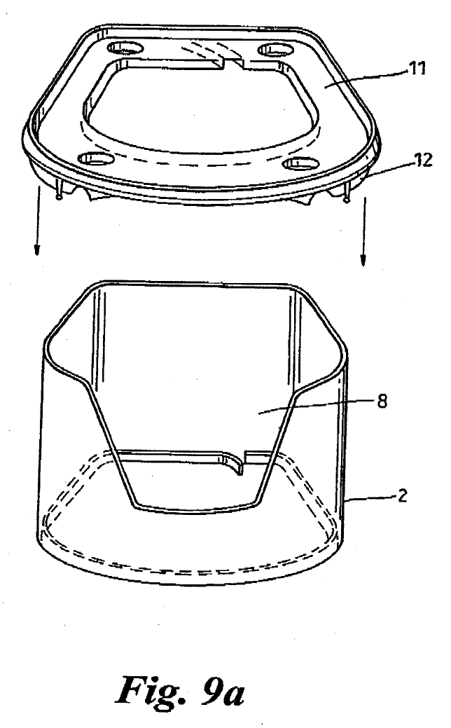

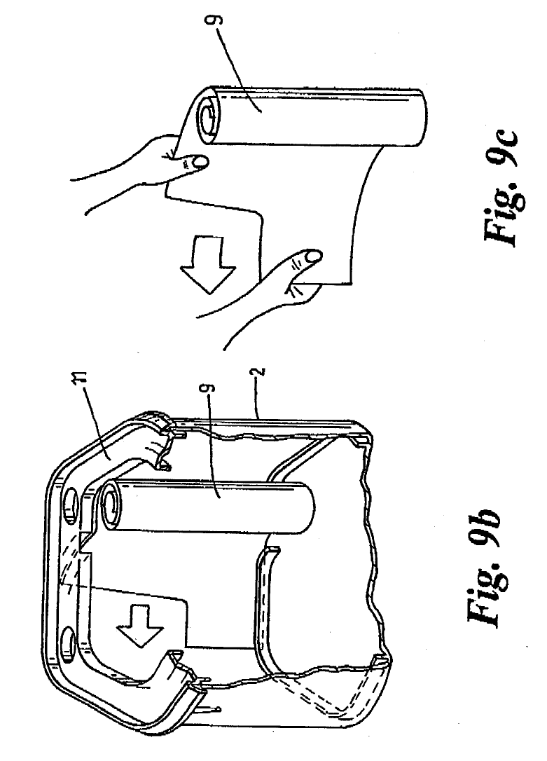

FIGS. 9a, 9b and 9c are views similar to FIGS. 7a, 7b and 7c, but illustrate a container of semi-circular section.

A display unit 1 as shown in the drawings comprises a number of cylindrical containers 2 stacked one upon the other, and examples of display units comprising two, three or four containers 2 are shown in FIGS. 1, 2 and 4 of the drawings. The display unit shown in FIG. 1 has an uppermost container which is comprised by a header 3, which is in the form of an open container wherein half the side wall thereof is omitted.

The containers 2 are stacked one upon the other in the manner shown in FIG. 5, wherein the base 4 of the container has a peripheral recess 5 which rests on the peripheral lip 6 of another container on which it is stacked. As shown in FIG. 5 (and also in FIG. 6), the upper and lower edges of the cylindrical side wall of each container have a parallel reinforcement 7, to contain graphic.

The various containers 2 of each display unit 1 contain confectionery or snack foods such as packets of crisps, as shown in FIGS. 1, 2 and 4. Each of the containers has an opening 8 therein through which the goods displayed can be removed by the customer inserting his or her hand. The opening 8 may in particular be formed as shown in FIG. 6.

A sleeve 9 bearing advertising or other information is inserted into each container 2, by sliding the sleeve into the area immediately behind the outer skin of the container, as shown in FIG. 3. The sleeve 9 will have an opening 10 corresponding in shape to the opening 8 in the container 2.

The sleeve 9 will carry advertising material or other promotional material relating to the goods being displayed. For example, as shown in FIG. 4, the sleeve of the container may carry the brand name of the goods being displayed, while the sleeve of another container may carry details of a promotional offer. In any case, it will be apparent that the sleeves can be readily removed from the containers and replaced by other sleeves carrying different information, for example relating to another product to be displayed. Thus the containers comprising the display unit are graphically updateable in a simple manner by using slide-in graphic sleeves 9.

FIGS. 7a, 7b and 7c show the upper container 2 (having an opening 8) of a further embodiment of a display unit of the invention. A lid 11 is provided to snap onto the upper peripheral lip of the container 2 by means of resilient elements 12, as shown. A graphic sleeve 9 is unrolled within the container 2 and spread against the inner wall thereof. The container 2 and lid 11 are of circular section in this embodiment.

FIGS. 8a, 8b and 7c show an embodiment similar to that of FIGS. 7a, 7b and 7c, but wherein the container 2 and the lid 11 are of triangular section.

FIGS. 9a, 9b and 9c show another embodiment similar to that of FIGS. 7a, 7b and 7c, but wherein the container 2 and the lid 11 are of semi-circular section, more specifically the front part of the container having the opening 8 is semi-circular while the remaining part of the container and lid is trapezium-shaped.

1. A display unit (1) comprising two or more stackable containers (2), each of which has an opening (8) through which goods being displayed can be removed, and in each of which can be inserted a removable sleeve (9) of material bearing advertising or other information, characterized in that the upper and lower edges of the side wall of at least one said container (2) have a parallel reinforcement (7) for retaining a said removable sleeve (9).

2. A display unit (1) comprising two or more stackable containers (2), each of which has an opening (8) through which goods being displayed can be removed, and in each of which can be inserted a removable sleeve (9) of material bearing advertising or other information, characterized in that at least one said container (2) is double-walled and the sleeve (9) is fitted between said double walls.

3. A display unit as claimed in claim 1 or 2, characterized in that said containers (2) are cylindrical in shape and are stacked one upon the other to form an upright cylindrical bin.

4. A display unit as claimed in any of claims 1 to 3, characterized in that the base (4) of the container (2) has a peripheral recess (5) which rests on the peripheral lip (6) of another container (2) on which it is stacked.

5. A display unit as claimed in any of claims 1 to 3, characterized in that the stacked containers (2) are positively locked together.

6. A display unit as claimed in any of claims 1 to 5, characterized in that the uppermost container of the unit comprises an open container (3) wherein a portion of the side wall thereof is omitted.

7. A display unit as claimed in any of claims 1 to 5, characterized in that the uppermost container of the unit is provided with a lid (11).
